(19) United States
(12) Patent Application Publication
(10) Pub. No.: US 2010/0119720 A1
(43) Pub. Date: May 13, 2010

(54) PROCESS FOR INSECTICIDAL IMPREGNATION OF A FABRIC OR NETTING OR OTHER KIND OF NON-LIVING MATERIAL

(76) Inventors: Mikkel Vestergaard Frandsen, Lausanne (CH); Finn Kjaergaard, Tjel (DK)

Correspondence Address: James C Wray, 1493 Chain Bridge Road, Suite 300, McLean, VA, 22101, US

(21) Appl. No.: 12/450,751

(22) PCT Filed: Apr. 10, 2007
(86) PCT No.: PCT/DK2007/000179

§ 371 Date: Nov. 18, 2009

(51) Int. Cl. B05D 1/36

(52) U.S. Cl. 427/412; 427/402; 427/416; 427/417; 427/407.1

(57) ABSTRACT

The present invention relates to a process—as disclosed in WO 01/37662 for the impregnation of a non living material, for example a fabric or a netting, so as to impart insect killing and/or repellence properties. The process involves the preparation of a solution of an insecticide and a film forming component reducing wash off and degradation of the insecticide, wherein said film forming component comprises a polymeric backbone fixative polymerizing into a film with polyflourocarbon side chains on the polymeric backbone in a drying and curing process of the non-living material. It has been found that the risk for precipitation of the insecticide in the solution of the insecticide is reduced if the insecticide is dissolved in a solvent combined with alcohol or glycol having a water content of less than 5%, and/or the insecticide is dissolved in a solvent and mixed with a water phase emulsion or solution having a temperature of less that 30° C.

### FIELD OF THE INVENTION

The present invention relates to a process—with reference to WO 01/37662—for the impregnation of a non living material, for example a fabric or a netting, so as to impart insect killing and/or repellence properties. The process involves the preparation of a solution of an insecticide and a film forming component reducing wash off and degradation of the insecticide, wherein said film forming component comprises a polymeric backbone fixative polymerizing into a film with side chains of paraffin oils or waxes, silicons, silicon oils or waxes, polyfluorocarbons, or derivatives thereof.

### BACKGROUND OF THE INVENTION

A number of different insects cause substantial problems as vectors and transmitters of infectious diseases affecting humans, and tremendous efforts are invested in controlling these insects. Efforts have been concentrated on controlling insects belonging to the order Diptera (covering mosquitoes, gnats, black flies, tsetse flies and other biting flies), Hemiptera (covering bed bugs) and Siphonaptera (covering fleas). Methods to control these insects include treating inner and outer surfaces of walls, air spraying, as well as impregnation of curtains and bednets. The impregnation of curtains and bednets has the advantage that the surface area to be treated is much reduced compared to a surface spraying of a house. The impregnation of the bednet reduces nuisance during sleeping and has been shown to be effective even if the net is slightly torn due to use.

The effect of a netting or fabric impregnated with a pyrethroid is partly based on the fast insecticidal property of these insecticides, but also on the repellent effect inherent in most of these insecticides. Tests have shown that an impregnated bednet reduces the number of mosquitoes entering the room with up till 75%. Thereby, the net also provides some protection for other persons sleeping in the same room even they are not covered by the net.

Large scale field experiments with nettings have shown that they may reduce malaria infection rate as measured directly or indirectly as gross children mortality. Accordingly, netting has been selected as a priority area for the campaign against malaria and other mosquito born diseases by WHO, the World Health Organization.

In some areas, mosquitoes are resistant to pyrethroids. One of these resistance types, so-called knock down resistance or KDR, also provides resistance to the repellent effect. This allows the mosquitoes to rest for a longer time on the net and thus to accumulate a lethal dosage of the insecticide, but it also gives the mosquitoes the possibility to bite before dying. In areas where these mosquitoes are dominating, a repellent can be added to the net with great advantage.

The advantages of the impregnated nets, curtains and fabric disappear at washing, since these impregnations are washed off with reduced effect as a consequence. The fabric or netting must then be re-impregnated according to washing rate, but this has in practice shown to be very difficult to organise, especially in remote African villages. Therefore, an impregnation method that provides wash resistance prolongs the period of protection of the net and promotes their use. According to International standards, a net should withstand at least 20 wash cycles and still release sufficiently amounts of insecticide.

The general and world wide preferred material for bednets is cotton and polyester. Nets of polyester have been chosen by the WHO as the favourite material for bednets due to their better strength, their cotton like feeling and reduced flammability. Opposite to that, nets of nylon are flammable, and polyethylene nets, like the Sumitomo® net with trade name Olyset®, are stiff. The Olyset® net is based on a monomer polyethylene fibre into which insecticide is incorporated during formation of the fibre. This method of incorporating the insecticide into the fibre is known not to be applicable for polyester fibres due to the high melting temperature of almost 200° C. for polyester, which is destructive for the pyrethroids.

WO 01/37662 by Skovmand discloses impregnated nettings or fabrics for insect or tick killing and/or repellent of an insect or tick comprising an insecticide, preferably a pyrethroid, and a film forming component reducing the wash off and degradation of the insecticide component from the netting or fabric by forming a water-resistant film. The film forming component comprises paraffin oil or wax derivatives, silicon derivatives, silicon oils or wax derivatives, and polyfluorocarbon derivatives in addition to a polymeric backbone fixative. The netting or fabric is impregnated by adding a solution or a water emulsion of an insecticide and/or repellent and a film forming component. The insecticide is dissolved in an organic solvent in the process for impregnation of a fabric or netting.

The composition and impregnation method as disclosed in WO 01/37662 has been used as a basis recipe for the mosquito net with the trade name Permanet® by Vestergaard Frandsen®. Though at the time of filing of WO 01/37662, the wash resistance was revolutionary already, improvements of the production process were still necessary along the line. During the experiments that have been carried out in connection with the maturing of the production recipe, one of the problems to overcome has been the instability of the insecticide during the blending process. A high risk for crystallisation of the used insecticide, especially deltamethrin, has been a limiting factor in the number of washes against which the nets were able to withstand before the level of insecticidal activity was below the widely used International threshold WHO standard.

### DESCRIPTION OF THE INVENTION

It is therefore the object of the invention to provide an improved method with a reduced risk for precipitation of the insecticide in the production process.

This object is achieved by a process for the impregnation of a fabric or a netting so as to impart insect killing and/or repellence properties, comprising:

a) preparing a solution or a water emulsion of an insecticide and/or a repellent and a film forming component reducing wash off and degradation of the insecticide component from the non-living material by forming a water and optionally oil resistant film on the surface of the non living material, for example around the fibres, and applying the solution or emulsion to the non living material, or

b) preparing a first solution or water emulsion of an insecticide and/or a repellent and preparing a second solution or water emulsion of a film forming component reducing wash off and degradation of the insecticide component from the non living material by forming a water and optionally oil resistant film on the surface of the non living material, for example around the fibres, and applying the solution or water emulsion of the insecticide and/or repellent on the non-living material and then applying the solution or emulsion of the film forming component to the non living material,

wherein said film forming component comprises a polymeric backbone fixative and one or more components selected from paraffin oils or waxes, silicons, silicon oils or waxes, and polyfluorocarbons, or derivatives thereof, wherein

i) the insecticide is dissolved in a solvent combined with alcohol or glycol, the alcohol or glycol has a water content of less than 5%,

or

ii) the insecticide is dissolved in a solvent and mixed with water or mixed with a water phase emulsion or solution having a temperature of less that 30° C., optionally, the solvent being combined with alcohol or glycol before the mixing,

or i) and ii).

As it has turned out during experiments, the two aspects i) and ii) both influence the precipitation of insecticide in the combined solution. This is especially true for pyrethroids, where the preferred insecticide is deltamethrin or permethrin. Thus applying either the step i) or applying the step ii) is an improvement as compared to to prior art, however, the best improvements are achieved by using a combination of i) and ii).

The water content of less than 5% is an important factor that has been found by trial and error, as there has not been found any indication in the prior art, that this level has to be reduced during for increase of the number of wash cycles. Typically, in the current processes, a water content of 3% or less is used.

The precipitation of the insecticide is dependent on the type of insecticide and the temperature. For deltamethrin, the temperature water phase emulsion or solution is advantageously below 24° C. and even more preferably below 20° C. The best results have been obtained at temperatures around 17° C. However, no significant improvement has been recognised at a much lower temperature, for example 5° C., why the temperature range of between 24° C. and 15° C. or rather between 20° C. and 15° C. are regarded as the best for pyrethroids, especially deltamethrin. The precipitation of deltamethrin at 17° C. as compared to more than 30° C.—which is a typical temperature in tropical factories—occurs much slower and with much smaller precipitated crystals. This implies that the final impregnation agent may be used over a larger time span during the production process if it is cooled. Whereas, the time between blending and impregnation at more than 30° C., for example 35° C., is in the order of one hour, the corresponding time at 17° C. is in the order of a day.

Often, precipitation of crystals cannot be entirely avoided. The aim is to reduce the speed of the precipitation and the size of the crystals. Large crystals of the insecticide are typically not desired, because they are quickly removed from the net or fabric due to mechanical effects when the net is touched, moved, etc.

In this context, it should be emphasized that mosquito nets are produced in tropical countries in production buildings without air condition having a temperature of more than 30° C. Thus, in order to achieve a temperature of 24° C. or less, active cooling of the liquid has to occur. In addition, in case that a mixing of the ingredients imply an exotherm process, or heating is necessary in order to achieve a satisfactory solution or emulsion, additional cooling is afterwards required to lower the temperature below the temperature of the environment.

In a further embodiment, the film forming component comprises a mixture of components selected from paraffin oils or waxes, silicons, and silicon oils or waxes, and polyfluorocarbon or derivatives thereof, preferably a mixture of a polyfluorocarbon and paraffinic oil or a mixture of a polyfluoroalkyl and a polysiloxan. For example, the silicon oil or wax is a polysiloxan.

In a further embodiment, the polyfluorocarbon, paraffin oil or wax, silicon, silicon oil or wax, or derivatives thereof is/are attached to the polymeric backbone. For example, the polymeric backbone fixative is a resin, polyurethane or polyacryl.

In a preferred embodiment, the film forming component comprises a polymeric backbone fixative polymerizing into a film with polyfluorocarbon side chains on the polymeric backbone in a drying process or in a curing process or in a drying and curing process of the non living material.

The combined solution or emulsion, where the insecticide composition is incorporated in the wash resistant agent before application to the non-living material, may be used as a composition for impregnation or as part of a composition for impregnation, in as much as it may be mixed with other components. Such components may be other insecticides, synergists, UV protecting agents, preservatives, detergents, fillers, impact modifiers, anti-fogging agents, blowing agents, clarifiers, nucleating agents, coupling agents, conductivity-enhancing agents to prevent static electricity, stabilizers, for example, anti-oxidants, carbon and oxygen radical scavengers and peroxide decomposing agents and the like, flame retardants, mould release agents, optical brighteners, spreading agents, antiblocking agents, anti-migrating agents, foam-forming agents, anti-soiling agents, thickeners, further biocides, wetting agents, plasticizers adhesive or anti-adhesive agents, fragrance, pigments and dyestuffs and other liquids including water or organic solvents.

The impregnating composition may also be partly absorbed in an absorptive fabric, which may prolong the insecticidal activity and improve the wash resistance. In the case of the fibres being multifilament yarn, insecticide may be trapped between the filaments, leading to a higher wash resistance of this trapped insecticide. The method according to the invention is applicable for hand dipping, however, it has proved to be especially suitable for industrial production.

The protective composition according to the invention relates to a single component or a mixture of components giving water or water and oil resistance. One or several detergents may be added to increase wettability of the agent to the fabric, to stabilise emulsions used, or to increase fixation. A cross-linking agent or a catalyser may be used to increase fixation. The pesticidal composition and the protective composition may be added successively (process a) or in one process (process b). An improved finish and curing may be obtained by finally passing a heated surface, for example, an iron or a heated roller or heating with hot air.

The polymeric backbone is discussed in more detail in WO 01/37662, the content of which is incorporated herein in its entirety by reference.

Insecticides and Synergists

Preferably, the insecticide is a pyrethroid, preferably deltamethrin or permethrin, but other pyrethroids may apply as well, as disclosed as a list in WO 01/37662. However, the invention applies as well in connection with cabamates or organophosphates in the composition for impregnation. A more extensive list of possible insecticide is found in WO 01/37662 or in WO 06/128870 also containing examples of repellents.

In addition, the term insecticide applies as well to insecticide combinations in the composition for impregnation according to the invention. For example, a pyrethroid may be combined with carbamates or organophosphates in order to combat resistant insects as well. Also, two or more insecticides may be applied on various parts of the net or fabric and not mixed and used homogeneously, which can be beneficially with respect to toxicological and registration reasons. Where nets are used in mass campaigns, the alternative or supplemental insecticide may also be an insecticide with a sterilising effect for sterilising the mosquitoes and avoid the next generation of mosquitoes. Such insecticides can, optionally, be of the benzoyl urea group or triazins.

Further possible combinations include
a phenylsemicarbazone compound, preferably metaflumizone, as disclosed in international patent applications WO07/017518, WO07/017502 assigned to BASF and WO 06/127407 assigned to Wyeth,
an anthranilamid as disclosed in international patent application WO07/017433,
N-arylhydrazine as disclosed in international patent application WO06128870,
derivatives of 1-Phenyltriazole as disclosed in international patent application WO06128867, for example combined with a pyrethroid,
1-(Imidazolin-2-YL)Amino-1,2-Diphenylethane compounds as disclosed in international patent application WO06/125748,
1-(1,2-Diphenyl-ethyl)-3-(2-Hydroxyethyl)Thiurea compounds as disclosed in international patent application WO06/125745,
Malononitriles as disclosed in international patent application WO06/122949,
Biphenyl-N-(4-Pyridyl)Methylsufonamides as disclosed in international patent application WO06/097488 or WO06/097489,
Amidrazone compounds as disclosed in international patent application WO06/097279,
Hydrazide compound as disclosed in international patent application WO06/058730,
Azine compound also as disclosed in international patent application WO06/056462,
2-cyano-3-(halo)alkoxy-benzenesulfanomide as disclosed in international patent application WO06/056433,
Nanoparticulate organic pesticide compound as disclosed in international patent application WO06/002984,
N-arylhydrazine derivatives as disclosed in international patent applications WO05/053402 or WO05/053403,
5-(2-Arylacetanido)Isothiaziole compounds as disclosed in international patent applications WO05/040162 or WO05/040143,
Fluoralkene derivative as disclosed in international patent application WO04/013112.

In addition, or alternatively, insecticides may be combined with synergists, for example piperonyl butoxide, Sulfoxide, Tropital, Bucarpolate, ethion, profenofos, or dimethoate.

Non Living Material

In the following, a number of examples of non-living material in the context of the invention are given,
a textile material or plastics material selected from the group consisting of yarn, fibers, fabric, knit-goods, nonwovens, netting material, foils, tarpaulins and coating compositions. The netting material may be prepared by any method known in the art, for example by circular knitting or warp knitting, or by sewing parts of a netting to obtain the desired nettings. The textile material or plastics material may be made form a variety of natural and synthetic fibers, also as textile blends in woven or non-woven form, as knit goods, yarns or fibers. Natural fibers are for example cotton, wool, silk, jute or hamp. Synthetic fibers are for example polyamides, polyesters, polyacryl nitriles, polyolefines, for example polypropylene or polyethylene, Teflon, and mixtures of fibers, for example mixtures of synthetic and natural fibers. Polyamides, polyolefins and polyesters, for example polyethylene terephthalate, are preferred;
non-textile substrates, for example, coating compositions, leathers, synthetic adaptions of leather, flocked fabrics, sheetings, foils and packaging material:
and also wooden materials, for example, houses, trees, board fences, or sleepers and also paper;
protective window and closet gratings or grills made from suitable metals.

Application of textile material or plastics material includes bedclothes, mattresses, pillows, duvets, cushions, curtains, wall coverings, carpeting and window, cupboard and door screens, geotextiles, tents, inner soles of shoes, garments, for example, socks, trousers, shirts, uniforms, horse blankets, bed nets, covering in agriculture and viniculture; fabrics or nettings for packages, wrapping sacks; containers for food, seeds and feed; paper; construction materials, furniture, leathers, vinyl articles, electric wires and cables.

Most preferred are nettings made from polyester, because polyester nettings have cotton like feeling and low flammability. These are also reasons, why these netting are preferred by the WHO. In this regard, it is emphasized that the invention is one embodiment is directed towards application in connection with a 75, 100 or 150 denier 36 filament deltamethrin impregnated polyester netting like Permanet 2.0.

Further special applications in connection with the invention are as,
fencing, such as disclosed in WO03003827,
pesticidal blanket, such as disclosed in WO03055307,
protective cover for food and water storage containers, such as disclosed in WO03090532,
air cleaning canopy, such as disclosed in WO2006024304.

Solvent

Suitably, the insecticide is dissolved in a proper solvent, for example acetone, hexane, heptane, ligroin and petroleum ether; aromatic hydrocarbon solvents, for example, benzene, toluene and xylene; halogenated hydrocarbon solvents, for example, chloroform, carbon tetrachloride, dichloroethane, chlorobenzene and dichlorobenzene; ether solvents, for example, diethyl ether, diisopropyl ether, dioxane, tetrahydrofuran and ethylene glycol dimethyl ether; ester solvents, for example, ethyl acetate and butyl acetate; nitro compounds, for example, nitroethane and Nitrobenzene; dimethylformamide; and mixtures thereof.

Insects

The aim of the invention is to control and/or to combat a variety of pests, for example ticks, cockroaches, bed bugs, mites, fleas, lice, leeches, houseflies, mosquitoes, termites, ants, moths, spiders, grasshoppers, crickets, silverfish, and other flying and crawling insects.

The Applying Process

The applying of the insecticidal impregnation composition may be performed by padding, dip washing, spraying, printing techniques, for example transfer printing or analogous to inkjet printing.

The Curing Process

After application of the liquid composition to the non-living material, a drying process is performed followed by a curing process at elevated temperatures relative to the temperature of the environment. Alternatively, the drying and curing process is performed in one step simultaneously. The time and temperature for the curing process depends on the non-living material and on the insecticide. At the same elevated temperature, for example 120° C., some insecticides disintegrate easier and faster than others. For example, deltamethrin disintegrates rather fast at higher temperatures or changes into R-isomers, for example at temperatures of 110° C. or higher, and should not be exposed to high temperatures for a substantial time. However, this does exclude that the impregnation composition during the drying process is exposed to heated rollers of much larger temperature, for example 170° C. or even higher temperature, for example 180° C. or even 200° C., as long as the temperature of the composition itself does not achieve that temperature for a substantially long time. As long as the impregnated non-living material is wet, evaporation of the fluid may keep the temperature low enough to prevent substantial disintegration or sublimation of the insecticide.

As an example for the curing process, deltamethrin has been found to stay largely intact, if the curing temperature is between 70 and 90° C., rather within the open range between 70° C. and 90° C., such as 71° C.-89° C., preferably between 75° C. and 85° C., more preferably between 75° C. and 80° C. and most preferably in the rather narrow interval between 75° C. and 79° C. In successful experiments, typical curing time intervals were in the range of 5 seconds to 2 minutes. However, there seems to occur some further curing at room temperature thereafter. However, as long as the net is not dried, a slightly higher drying temperature of 90° C. is applicable, followed by a curing process in the above mentioned range.

Often, impregnated fabrics or nets are produces in tropical countries, where the temperature is high enough to achieve a fast drying of the impregnation composition. However, it is preferred to dry the material at elevated temperature. Experimentally, it has been found that a drying process at 70° C. to 90° C., rather around 90° C., is suitable for a high production speed. Furthermore, a better adhesion of the binder is found than by drying at low temperature, for example at 30° C. Typical drying times have been between 5 seconds and 2 minutes in successful experiments.

### SHORT DESCRIPTION OF THE DRAWINGS

The invention will be explained in more detail with reference to the drawing, where

FIG. 1 is a simplified illustration of a water repellant polymeric backbone

FIG. 2 illustrates the inclusion of insecticide in the backbone,

FIG. 3 illustrates a backbone with insecticide before alignment.

### DETAILED DESCRIPTION/PREFERRED EMBODIMENT

In the following, an example of a process for production of a netting or fabric, preferably a mosquito net, is described.

The Knitting, Cleaning, Colouring, Sewing and Packing

Drawn texturised polyester fibre yam (DTY) is delivered in rolls from a supplier, where the fibres consist of 36 polyester filaments. The delivered fibres are knitted into continuous nets and stretched in order achieve the correct dimension followed by a heat setting process at various temperatures between 170° C. and 225° C., where the net is stretched simultaneously to make the net more stable and more stiff.

Before the nets are optionally coloured, sewed into the right dimensions and packed, they are subjected to the impregnation process.

The Impregnation Process

In the two-step process a), the solution of the insecticide is mixed with alcohol or glycol (ethyl-alcohol, propylenglycol, etc.) and the fabric or netting passes through a bath with the insecticidal liquid, or the insecticidal liquid is applied to the fabric or netting by spraying, printing or other techniques. Especially suited for industrial production, to reduce the amount of solvents used in the process, the fabric or netting passes two rollers or a roller against a fixed surface to squeeze off as much as possible of the fluid. The concentration of the pyrethroid in the solution is calculated on the amount of solution remaining in the fabric or on the netting after this process. The fabric or netting is then dried, e.g. by a passing air stream or in an oven. The fabric and especially the netting may be kept fixed under this process not to change shape. The temperature used in the drying process must be below 220° C., and preferably below 100° C. in the composition itself. After drying, the fabric or netting pass a second bath, spray station, printing station, or the like, where a solution or emulsion of the wash resistant agent is added. A cross binding or a catalysing agent may be added. This emulsion with polyfluorocarbon forms a continuous film during evaporation of the water.

In the one-step process b), which is the preferred method, the solution of the insecticide is mixed with alcohol or glycol (ethyl-alcohol, propylenglycol, etc.). This mixture is then mixed under stirring with an organic solution or a water emulsion of the wash protective agent, optionally with the addition of catalytic or cross binding agent and an acidifier. Detergents may be added to stabilise the organic solution of the pesticide in the water emulsion and to ease wetting. After completely wetting, the fabric or netting may pass a press, e.g. comprising two rollers, to reduce the amount of composition absorbed. Alternatively, surplus composition may be removed by centrifuging. The fabric or netting is finally dried, as described above, or dried by passing a warm surface, for example over a warm roller. Alternatively, the fabric may be partly or totally air dried. e.g. under vacuum, and then passed between one or two heated rollers or a roller and a heated surface. For the netting, the temperature during the drying process has to be chosen such that the insecticide is not decomposed. This final drying at elevated process also serves to accelerate the orientation of the molecules of the wash protective agent to form a homogenous wash repellent film. This process is often named as the “curing”.

The Impregnation Process for a Mosquito Net

In a preferred embodiment, especially used for mosquito nets, deltamethrin is dissolve/dispersed in acetone and ethanol, where the ethanol has a water content of less than 5% and is used as a stabiliser, for example between 5% and 3%, around 3% or lower than 3%, for example between 3% and 1%, or even lower than 1%.

The film forming component is dissolved/dispersed in hot water together with a stabiliser/emulsifier, where also an acidifier is used. The hot mixture is cooled to below 20° C., rather to approximately 17° C. or below 17° C., before the deltamethrin solution/emulsion is mixed into the cooled mixture.

The final mixture with the insecticide and the film forming agent is applied to the net by padding, where the net run over rollers at a controlled speed. For a net as PermaNet®, the initial pick up weigh is selected so that after drying, the final deltamethrin content is 55 mg/m² net.

The Curing Process

The effect of the curing process is described in the following in a very simplified model, which, however, may help to understand the functioning of a polymeric backbone in connection with insecticides.

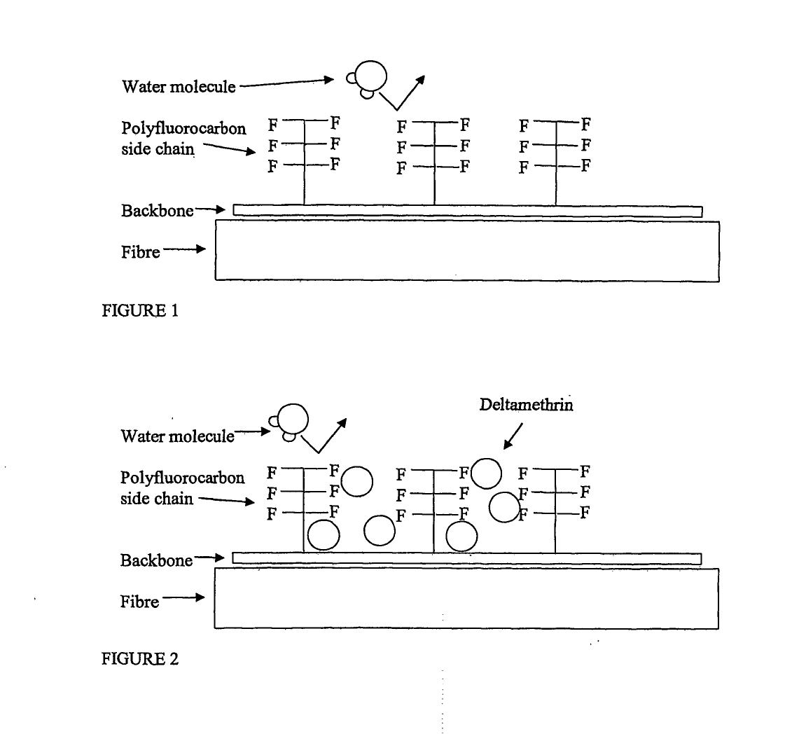

In FIG. 1, a simplified sketch is shown of a polymeric backbone on a fibre. The backbone has side chains with polyfluorocarbons which, as a film with a high number of such backbone polymer chains, acts as a water repellent and, optionally oil repellent coating.

As illustrated in FIG. 2, insecticide may be trapped between these side chains. This implies that the insecticide is protected from water or oil on the surface as long as the insecticide in within the backbone. In this connection, it is important that the insecticide is trapped releasably between the side chains. In other words, the insecticide should have a mobility such that it can migrate to the surface of the film, out of the backbone in order for uptake by insects. The migration may be at least partly governed by a gradient of insecticide concentration, but active migration promoters or inhibitors may be applied as well in order to find the optimal migration speed, such that a sufficiently high dose of insecticide is on the outer surface of the fibre over a prolonged period.

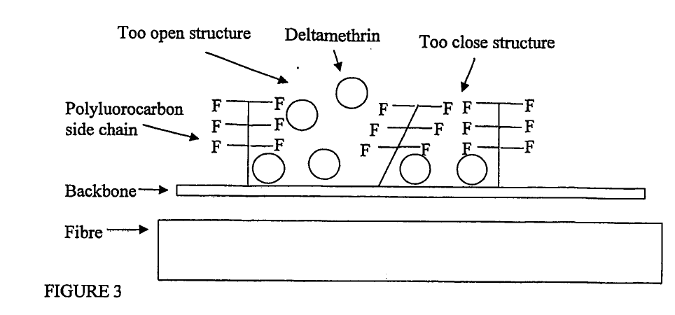

If the side chains of the polymeric backbone are misaligned, as illustrated in FIG. 3, some of the insecticide may be trapped into too close structures with a reduced migration speed as a result. Other side chains may form a too open structure, which does not lead to sufficient protection against water and oil. The curing process is believed to realign the side chains such that optimal conditions are achieved.

For PermaNet®, deltamethrin has been used, normally, and, deltamethrin has been found to stay largely intact, if the curing temperature is between 70° C. and 90° C., rather within the open range between 70° C. and 90° C., for example 71° C.-89° C., preferably between 75° C. and 85° C., more preferably between 75° C. and 80° C. and most preferably in the rather narrow interval between 75° C. and 79° C. In successful experiments, typical curing time intervals were in the range of 5 seconds to 2 minutes. However, there seems to occur some further curing at room temperature thereafter.

However, as long as the net is not dried, a slightly higher drying temperature of 90° C. is applicable, followed by a curing process in the above mentioned range. Often, impregnated fabrics or nets are produces in tropical countries, where the temperature is high enough to achieve a fast drying of the impregnation composition. However, it is preferred to dry the material at elevated temperature. Experimentally, it has been found that a drying process at 70° C. to 90° C., rather around 90° C. leads to a higher content of insecticide, especially deltamethrin, as compared to a drying at 30° C. In successful experiments, typical drying time intervals were in the range of 5 seconds to 2 minutes.

Further non Limiting Examples

To further illustrate the invention, in the following a few non-limiting examples are described.

In the method a) according too the invention, where a single formulation is produced for the impregnation, an illustrating example of the process may shortly be described as the following:
deltamethrin is dissolved or dispersed in acetone combined with ethanol, the ethanol has a water content of less than 5%,
optionally, the deltamethrin solution or dispersion may be mixed with water with a temperature of less than 30° C.,
the film forming component is dissolved or dispersed in water
the deltamethrin solution is stirred into the water solution or dispersion, optionally having a temperature of less than 30° C., to form the impregnation liquid,
and a fabric or netting is treated with the impregnation liquid and dried or cured at elevated temperature.

Another example of the method a) according too the invention is
deltamethrin is dissolved or dispersed in acetone combined with ethanol, optionally the ethanol has a content of less than 5% water,
optionally, the deltamethrin solution or dispersion may be mixed with water of less than 30° C.,
the film forming component is dissolved or dispersed in water
the deltamethrin solution is stirred into the water solution or dispersion of less than 30° C. to form the impregnation liquid,
and a fabric or netting is treated with the impregnation liquid and dried or cured at elevated temperature.

A non limiting, shortly described example of the method b) according too the invention is
pyrethroid or carbamate is dissolved or dispersed in acetone combined with glykol, the glykol has a content of less than 5% water,
optionally, the pyrethroid or carbamate solution or dispersion may be mixed with water of a temperature less than 30° C.,
the fabric is treated with the pyrethroid or carbamate solution or dispersion,
optionally, the fabric is dried,
the film forming component is dissolved or dispersed in water
and a fabric or netting is treated with water solution or dispersion of the film forming component and dried or cured at elevated temperature, wherein the film forming component solution or dispersion is applied after the application of the pyrethroid or carbamate solution or dispersion.

1-18. (canceled)

19. A process for the impregnation of a non living material, for example a fabric or a netting, so as to impart insect killing and/or repellency properties, comprising:
a) preparing a solution or a water emulsion of an insecticide and/or a repellent and a film forming component reducing wash off and degradation of the insecticide component from the non-living material by forming a water and optionally oil resistant film on the surface of the non living material, for example around the fibers, and applying the solution or emulsion to the non living material, or
b) preparing a first solution or water emulsion of an insecticide and/or a repellent and preparing a second solution or water emulsion of a film forming component reducing wash off and degradation of the insecticide component from the non living material by forming a water and optionally oil resistant film on the surface of the non living material, for example around the fibers, and applying the solution or water emulsion of the insecticide and/or repellent on the non-living material and then applying the solution or emulsion of the film forming component to the non living material,
wherein said film forming component comprises a polymeric backbone fixative and one or more components selected from paraffin oils or waxes, silicons, silicon oils or waxes, and polyfluorocarbons, or derivatives thereof, wherein:
i) the insecticide is dissolved in a solvent combined with alcohol or glycol, the alcohol or glycol has a water content of less than 5%, or
ii) the insecticide is dissolved in a solvent and mixed with water or mixed with a water phase emulsion or solution having a temperature of less that 30° C., optionally, the solvent being combined with alcohol or glycol before the mixing, or both i) and ii).

20. A process according to claim 19, wherein the temperature of the water phase solution or emulsion is less than or equal to 20° C.

21. A process according to claim 19, wherein the alcohol or glycol has a water content less than or equal to 3%.

22. A process according to claim 21, wherein the alcohol or glycol has a water content of between 3% and 1%.

23. A process according to claim 19, wherein the alcohol or glycol has a water content of between 5% and 1%.

24. A process according claim 19, wherein the film forming component is mixed with an emulsifier or stabilizer or both in water solution before mixing with the insecticide solvent or emulsion.

25. A process according to claim 24, wherein the film forming component is mixed with an emulsifier or stabilizer or both in water solution at elevated temperature and afterwards cooled down to less than 30° C. before mixing with the insecticide solution or emulsion.

26. A process according to claim 24, wherein the film forming component is mixed with an emulsifier or stabilizer or both in water solution at elevated temperature and afterwards cooled down to less than 20° C. before mixing with the insecticide solution or emulsion.

27. A process according to claim 19, wherein the non living material is dried at a temperature in the order of 90° C.

28. A process according to claim 19, wherein the non living material is cured at a temperature between 70° C. and 90° C.

29. A process according to claim 19, wherein the curing temperature is between 75° C. and 79° C.

30. A process according to claim 19, wherein the insecticide is a pyrethroid.

31. A process according to claim 30, wherein the insecticide is deltamethrin.

32. A process according to claim 19, wherein the process comprises:
knitting a 36 fibre polyester yarn into a net,
stretching the net under wet conditions in order achieve the correct dimension followed by a heat setting process at temperatures between 170° C. and 210° C. to make the net more stable and more stiff,
impregnating the net,
drying the net at a temperature in the order of 90° C., and curing the net at a temperature of between 75° C. and 79° C.

33. A process according to claim 19, wherein the film forming component comprises a mixture of components selected from paraffin oils or waxes, silicons, and silicon oils or waxes, and polyfluorocarbon, or derivatives thereof.

34. A process according to claim 19, wherein the said film forming component comprises a mixture of a polyfluorocarbon and a paraffinic oil or a mixture of a polyfluoroalkyl and a polysiloxan.

35. A process according to claim 19, wherein the silicon oil or wax is a polysiloxan.

36. A process according to claim 19, wherein the polymeric backbone fixative is a resin, polyurethane or polyacryl.

37. A process according to claim 19, wherein the polyflurocarbon, paraffin oil or wax, silicon, silicon oil or wax, or derivatives thereof is/are attached to the polymeric backbone.

38. A process according to claim 19, wherein said film forming component is polymerizing into a film with polyflourocarbon side chains on the polymeric backbone in a drying process or in a curing process or in a drying and curing process of the non living material.
